(19) United States
(12) Patent Application Publication
(10) Pub. No.: US 2002/0105796 A1
(43) Pub. Date: Aug. 8, 2002

(54) Tool light and method of use

(75) Inventors: David Naghi, Los Angeles, CA (US); Eric A. Hanscom, San Pedro, CA (US)

Correspondence Address: STEPHEN C. BEUERLE, PROCOPIO, CORY, HARGREAVES & SAVITCH, 530 B STREET, SUITE 2100, SAN DIEGO, CA, 92101-4469, US

(73) Assignee: Technology Creations, Inc.

(21) Appl. No.: 09/778,251

(22) Filed: Feb. 6, 2001

(51) Int. Cl. B25B 23/18

(52) U.S. Cl. 362/120; 362/276; 362/295

(57) ABSTRACT

A tool light and method of using the same for illuminating a work area for a tool. The tool light includes a mounting mechanism to be mounted to a shaft of a tool, a housing carried by the mounting mechanism, at least one light source and at least one power source housed within the housing, and the at least one light source powered by the at least one power source to illuminate the work area for the tool. The method includes mounting the tool light to the shaft of the tool, and illuminating the work area with the at least one light source of the tool light. The at least one light source is preferably at least one Light Emitting Diode (“LED”).

### FIELD OF THE INVENTION

The present invention is in the field of lighting devices for illuminating the work area for a tool with a shaft such as a screwdriver.

### BACKGROUND OF THE INVENTION

It is often desirable to use a tool such as screwdriver inside a cabinet, attic, or other tight location where inadequate lighting exists. A flash light or drop light may be used to provide lighting in some circumstances, but in tight spots, neither of these lights will work, if an extra hand is not available, a flashlight may not work, and if an AC power source is not available, a drop light will not work.

Also, use of a flashlight in one hand while operating a hand tool with another, particularly when the hand tool is normally operated with two hands, e.g., power drill, may be dangerous. Further, as is frequently done, when a flashlight is balanced on a shelf or other support surface not intended to support a flashlight and the flashlight tips over or shifts positions, the tool user's lighted view can be suddenly terminated as the flashlight moves away, creating an inherently dangerous situation where the user is now using a potentially dangerous hand or power tool in inadequate lighting conditions.

U.S. Pat. Nos. 5,038,481, 5,348,359, and 5,525,842 disclose lighting devices for lighting the work area for a saber saw, a retriever tool, and an air tool, respectively. A problem with these lighting devices is that they are not readily mountable to a variety of different tools, especially tools with a shaft such as screwdrivers.

Accordingly, a need exists for a simple tool light that is readily mountable to a variety of different tools including a shaft such as a screwdriver and that illuminates the working area for the tool, even in tight working conditions.

### SUMMARY OF THE INVENTION

The present invention is generally directed to a tool light and method of use that may be used with a variety of different tools including a shaft.

An additional aspect of the invention involves a tool light for illuminating a work area for a tool. The tool light includes a mounting mechanism to be mounted to a shaft of the tool, a housing carried by the mounting mechanism, at least one light source and at least one power source housed within the housing, and the at least one light source powered by the at least one power source to illuminate the work area for the tool. In a preferred implementation of the above, the at least one light source includes at least one Light Emitting Diode (“LED”).

Another aspect of the invention involves a method of illuminating a work area for a tool. The method includes mounting the tool light to a shaft of the tool, and illuminating the work area with at least one light source of the tool light. In a preferred implementation of the above, the at least one light source includes at least one Light Emitting Diode (“LED”).

Further objects and advantages will be apparent to those skilled in the art after a review of the drawings and the detailed description of the preferred embodiments set forth below.

### BRIEF DESCRIPTION OF THE DRAWINGS

FIG. 1 is a side-elevational view of an embodiment of a tool light mounted to a shaft of a screwdriver.

FIG. 2 is an end view of the tool light illustrated in FIG. 1.

FIG. 3 is an end view of a tool light constructed in accordance with an additional embodiment of the invention.

FIG. 4 is a side-elevational view of another embodiment of a tool light mounted to a screwdriver.

FIG. 5 is a side-elevational view of a further embodiment of a tool light mounted to a screwdriver.

FIG. 6 is an end view of the tool light illustrated in FIG. 5.

FIG. 7 is a side-elevational view of a still further embodiment of a tool light that may be mounted to a screwdriver.

### DETAILED DESCRIPTION OF PREFERRED EMBODIMENTS

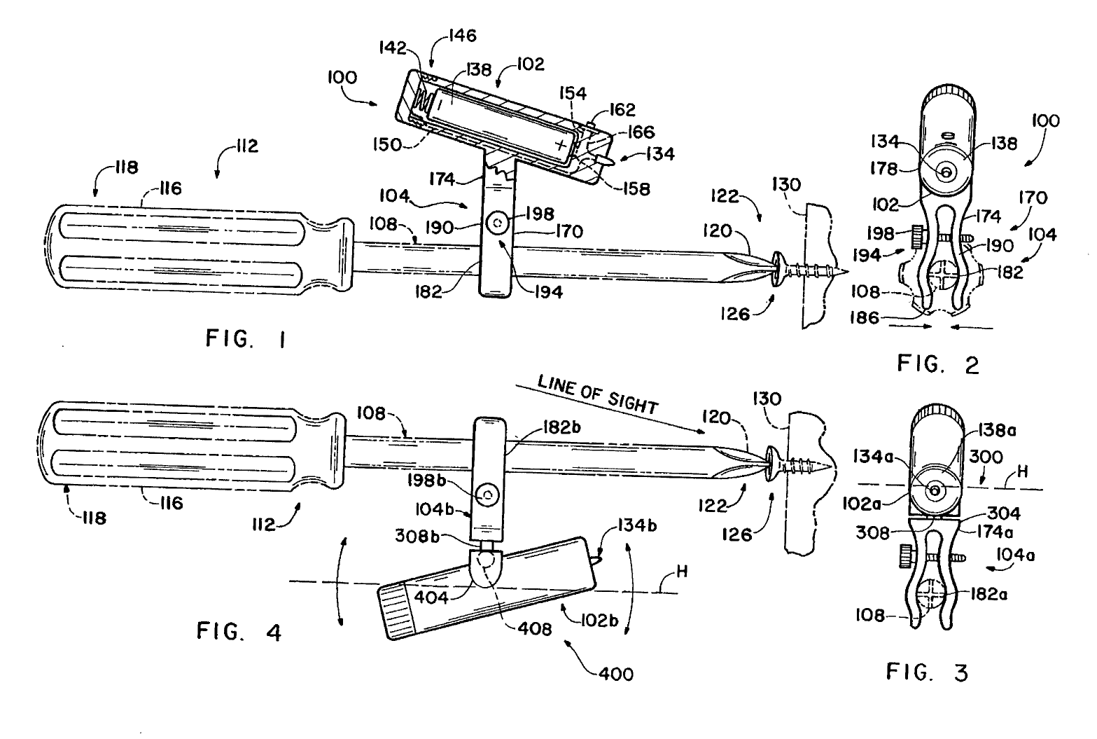

With reference to FIGS. 1 and 2, a tool light 100 constructed in accordance with an embodiment of the invention will now be described. The tool light 100 includes a light housing 102 carried by a mounting mechanism 104. The mounting mechanism 104 is used to mount the tool light 100 to a shaft 108 of a tool such as a screwdriver 112. Although the shaft 108 is shown as an elongated, circular shaft, the shaft 108 may have other lengths and configurations. For example, but not by way of limitation, the shaft 108 may have a square cross-section.

The screwdriver 112 includes a handle 116 at one end 118 of the shaft 108 and a head 120 at an operative or working end 122 of the shaft 108. In the embodiment shown, the screwdriver 112 is a cross-headed tip (e.g., Phillips) screwdriver. The screw driver 112 may be used to screw a screw 126 into a surface 130. Although the illustrated tool is a cross-headed tip screwdriver 112, the tool light 100 may be applied to shafts of tools other than the cross-headed tip screwdriver such as, but not by way of limitation, a flat-tip screwdriver, a square-headed tip screwdriver, other types of screwdrivers, a power drill, a chisel, a caulking gun, a soldering torch, a soldering gun, a cutting torch, a welding torch, and a voltage tester.

The light housing 102 is preferably cylindrical and houses a light source 134 and a power source 138. The light source 134 is preferably one or more wide-angle (i.e., 40 degrees or greater), white LEDs; however other light sources, e.g., incandescent light bulbs, other angle LEDs, other types of LEDs, e.g., flat, pointed, and other color LEDs may be used. In the embodiment shown, the power source 138 is preferably a single AA, AA, or AAAA battery. In alternative embodiments, power sources other than batteries, e.g., miniature fuel cells, different types of batteries, e.g., rechargeable batteries, flat watch batteries such as alkaline 625 cells and NiCd batteries, and different numbers of batteries, e.g., two or more may be used.

A contact spring 142 may be located in a proximal portion 146 of the housing 102 for contacting the negative terminal of the battery 138. A first electrical coupling 150 may connect the contact spring 142 to the LED 134. A second electrical coupling 154 may connect a positive terminal contact 158 to an electrical on/off switch 162. A third electrical coupling 166 may connect the switch 162 to the LED 134. In an alternative embodiment, the electrical circuitry may include a motion sensor mechanism to activate the LED 134 when motion is detected and deactivate the LED 134 when no motion occurs for a prolonged period of time. The electrical circuitry may also include a dimmer mechanism, e.g., variable resistor, for controlling the intensity of the emitted light from the LED 134.

The mounting mechanism 104 may include a dual-collar member 170. The member 170 may include a first collar 174 that carries the light housing 102 at a predetermined or adjustable angle. The light housing 102 may be connected within the first collar 174 by a pair of spot welds 178 or by another connecting means. A second collar 182 receives the shaft 108 of the screwdriver 112. The second collar 182 may come in a variety of different sizes for accommodating different-sized shafts, tools. The second collar 182 includes an open end 186. The dual-collar member 170 includes an intermediate section 190. The intermediate section 190 may include a tightening mechanism 194 for increasing the holding force of the second collar 182 on the shaft 108 in the direction of the arrows shown in FIG. 2. The tightening mechanism 194 may include a threaded fastener 198 that is threadingly engaged within holes in the intermediate section 190.

The tool light 100 will now be described in use. The tool light 100 is mounted or applied to the shaft 108 of the screwdriver 112 by inserting the head 120 of the screwdriver 112 through the second collar 182 and sliding the tool light 100 forward or rearward on the shaft 108 to a position where the working end 122 of the screwdriver 112 and/or the working area is optimally lit by the light source 134, i.e., the light is optimally focused. Alternatively, the second collar 182 may be clamped onto the shaft 108 by snapping the collar 182 onto the shaft 108 through the open end 186 of the second collar 182. The light source 134 is activated by moving the switch 162 to an “on” position and deactivated by moving the switch 162 to an “off” position. The tool light 100 may be slid forward or rearward on the shaft 108 to a position where the working end 122 of the screwdriver 112 and/or the working area is optimally lit by the light source 134. When the tool light 100 is located in a desired position, the tightening mechanism 194 may be actuated to secure the tool light 100 to the shaft 108 by rotating and tightening the threaded fastener 198 in a clockwise direction. The tool light 100 may be removed from the shaft 108 of the screwdriver 112 by rotating and loosening the threaded fastener 198 in a counterclockwise direction. The tool light 100 may then be mounted to a different tool in the same manner as that described above or stored for later use.

With reference to FIG. 3, a tool light 300 constructed in accordance with an additional embodiment of the invention will now be described. Elements similar to those described above with respect to FIGS. 1 and 2 are identified with like reference numerals, but with an “a” suffix. The tool light 300 is similar to the tool light 100 described above with respect to FIGS. 1 and 2, except the light housing 102a is rotatably attached to the mounting mechanism 104a. The first collar 174a may include a support 304 that rotatably receives a rotating pin 308. The rotating pin 308 supports the light housing 102a for general rotation of the light housing 102a with the pin 308 in a horizontal plane H.

Use of the tool light 300 is similar to that described above for the tool light 100, except the light housing 102a may be additionally rotated in a horizontal plane for adjusting the orientation of the light source 134a to an optimal condition for lighting the work area.

With reference to FIG. 4, a tool light 400 constructed in accordance with another embodiment of the invention will now be described. Elements similar to those described above with respect to FIGS. 1-3 are identified with like reference numerals, but with a “b” suffix. The tool light 400 is similar to the tool light 300 described above with respect to FIG. 3, except a rotating support 404 is rotatably mounted to the mounting mechanism 104b by rotating pin 308b for general rotation of the light housing 102b in horizontal plane H. The light housing 102b is pivotally mounted to the support 404 through a pin 408 for pivotal movement of the light housing 102b in a vertical plane in the direction shown by the arrows.

Use of the tool light 400 is similar to that described above for the tool light 300, except the light housing 102b may be additionally rotated in a vertical plane in the direction of the arrows for adjusting the orientation of the light source 134b. In this embodiment (and the embodiment described with respect to FIGS. 1 and 2), the mounting mechanism 104b may be attached to the shaft 108 so that the light housing 102b is below the screwdriver 112. The mounting mechanism 104b may be loosely attached to the shaft 108 so that the tool light 400 hangs from the shaft 108, but does not rotate therewith during rotation of the screwdriver 112. The collar 182b may include bearings or a similar mechanism that allow the tool light 400 to hang from the screwdriver 112 to illuminate the working end 120 and/or working area while the shaft 108 freely rotates within the collar 182b, without the tool light 400 rotating with rotation of the shaft 108.

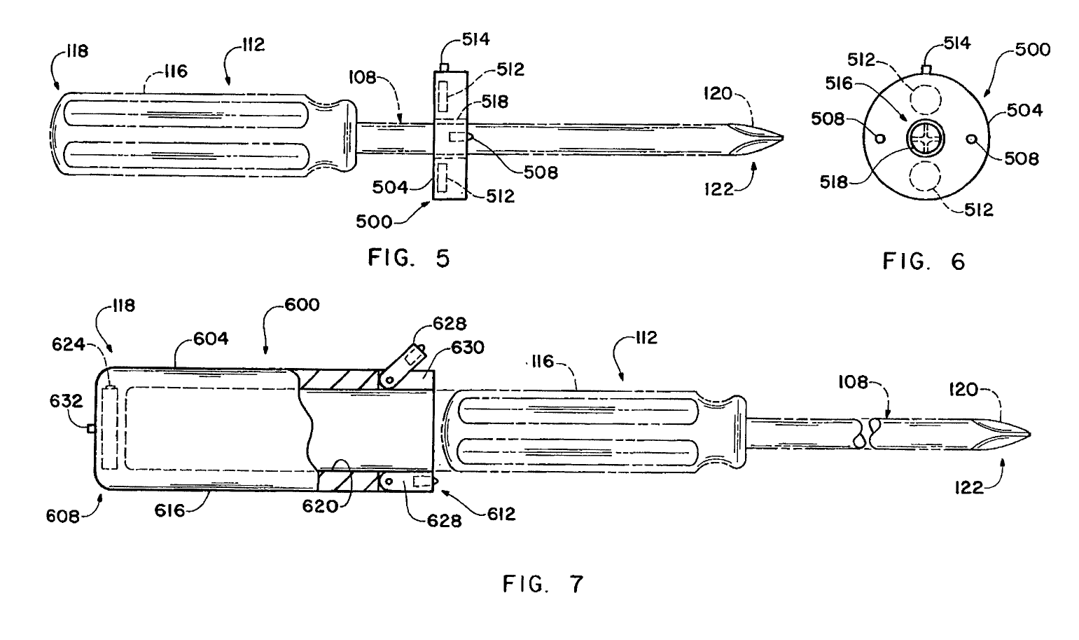

With reference to FIGS. 5 and 6, a tool light 500 constructed in accordance with a further embodiment of the invention will be described. The tool light 500 includes a ring-shaped light housing 504 that houses one or more light sources 508 and one or more power sources 512. In the embodiment shown, the one or more light sources 508 include a pair of LEDs oriented 180 degrees apart from each other and the one or more power sources 512 include a pair of watch batteries oriented 180 degrees apart from each other. The power sources 512 are offset 90 degrees from the light sources 508. The LEDs 508 may be angled inwardly, towards the center of the tool light 500. Electrical circuitry (not shown) connects the power sources 512 to the light sources 508 for powering the light sources 508. The electrical circuitry may include an on/off switch 514 for turning the light sources 508 on or off. In an alternative embodiment, the electrical circuitry of the tool light 500 may include a motion sensor mechanism to activate the light sources 508 when motion is detected and deactivate the light sources 508 when no motion occurs for a prolonged period of time. The electrical circuitry may also include a dimmer mechanism, e.g., variable resistor, for controlling the intensity of the emitted light from the light source(s) 508. A mounting mechanism 516 is located in a central portion of the tool light 500. In the embodiment shown, the mounting mechanism 516 is a flexible rubber grommet 518.

The tool light 500 will now be described in use. The shaft 108 of the screwdriver 112 is slidably inserted through the rubber grommet 518 of the tool light 500 until the tool light 500 a located at a desired longitudinal position on the shaft 108. If the LEDs 508 are angled inwardly, adjusting the longitudinal position of the tool light 500 changes the light focus on the working area. As a result, the tool light 500 may be used on a variety of different length tool shafts simply by adjusting the longitudinal position of the tool light 500 on the shaft for optimal light focusing. The rubber grommet 518 is flexible enough to accommodate different diameter and/or shaped shafts 108, while providing sufficient frictional resistance to hold the tool light 500 to the shaft 108. In alternative embodiments, replaceable rubber grommets 518 or different tool lights 500 having different inner diameters may accommodate different diameter and/or shaped shafts 108. The tool light 500 is activated and deactivated through the on/off switch 514 and/or through the motion detection mechanism. The tool light 500 preferably rotates with rotation of the shaft 108. In an alternative embodiment, an annular bearing mechanism may be located between the rubber grommet 108 and the inner central surface of the annular housing 504 so that the rubber grommet 108, but not the tool light 108, rotates with rotation of the shaft 108.

With reference to FIG. 7, a tool light 600 constructed in accordance with a still further embodiment of the invention will be described. The tool light 600 includes a cylindrical plastic or rubber sleeve 604. The sleeve 604 includes a proximal end 608, a distal end 612, and an elongated, ring-shaped wall 616. The wall 616 include an inner surface 620. The proximal end 608 may house one or more power sources 624 such as, but not limited to, one or more watch batteries. The distal end 612 may carry one or more retractable light sources 628, e.g. LED(s), in recessed areas 630. Each retractable light source 628 may be pivotally connected to the wall for pivotal movement between an outwardly pivoted or “on” position and a retracted or “off” position. Electrical circuitry (not shown) connects the power source 624 to the light sources 628 for powering the light sources 628. The electrical circuitry may include an on/off switch 632 for turning the light sources 628 on or off. In an alternative embodiment, the electrical circuitry of the tool light 600 may include a motion sensor mechanism to activate the light sources 628 when motion is detected and deactivate the light sources 628 when no motion occurs for a prolonged period of time. The electrical circuitry may also include a dimmer mechanism, e.g., variable resistor, for controlling the intensity of the emitted light from the light source(s) 628. Further, pivoting the light sources 628 to the outward position may automatically activate the light sources 628 and retracting the light sources 628 may automatically deactivate the light sources 628.

In use, the cylindrical sleeve 604 of the tool light 600 is slid over the handle 116 of the screwdriver 112, and the light sources 628 are actuated by pivoting them to the outward position, switching the on/off switch 632, and/or by automatic motion detection. When the light sources 628 are not in use, they may pivoted to a retracted or “off” position so that the light sources 628 are flush with the wall 604. During use, the tool light 600 rotates with rotation of the screwdriver 112.

In further embodiments, the features described above with respect to FIG. 7 may be incorporated into the handle 116 of the screwdriver or the light sources 628 may be fixed relative to the sleeve 604 or handle 116 (if incorporated into the handle 116).

It will be readily apparent to those skilled in the art that still further changes and modifications in the actual concepts described herein can readily be made without departing from the spirit and scope of the invention as defined by the following claims.

What is claimed is:

1. A method of illuminating a work area for a tool, comprising the steps of:
mounting a tool light to a shaft of the tool;
illuminating the work area with at least one light source of the tool light.

2. The method of claim 1, wherein the step of mounting includes sliding a mounting mechanism of the tool light over the shaft of the tool.

3. The method of claim 1, wherein the step of mounting includes clamping a mounting mechanism of the tool light to the shaft of the tool.

4. The method of claim 1, wherein the at least one light source is carried by a light housing, and the light housing is rotatable in a generally horizontal plane to orient the at least one light source to a desired lighting position.

5. The method of claim 1, wherein the at least one light source is carried by a light housing, and the light housing is rotatable in a generally vertical plane to orient the at least one light source to a desired lighting position.

6. The method of claim 1, wherein the step of mounting includes tightening a mounting mechanism of the tool light to the shaft with a tightening mechanism.

7. The method of claim 1, wherein the shaft is rotatable and the tool light includes a mounting mechanism mounted to the shaft so that the at least one light source rotates with the shaft while the shaft is rotated.

8. The method of claim 1, wherein the shaft is rotatable and the tool light includes a mounting mechanism mounted to the shaft so that the tool light does not rotate with the shaft while the shaft is rotated.

9. The method of claim 1, wherein the tool light has an annular shape and the step of mounting includes inserting the shaft through a center of the tool light and positioning the tool light at a desired location on the shaft.

10. The method of claim 1, wherein the at least one light source is powered by at least one power source, and the at least one light source and at least one power source are housed within a light housing.

11. The method of claim 1, wherein the at least one light source is powered by a rechargeable power source.

12. The method of claim 1, wherein the at least one light source is powered by at least one battery selected from the group consisting of an AA battery, an AAA battery, and an AAAA battery.

13. The method of claim 1, wherein the at least one light source is powered by at least one watch battery.

14. The method of claim 1, further including switching the at least one light source on and off with a switch.

15. The method of claim 1, wherein the at least one light source is at least one LED.

16. The method of claim 1, wherein the at least one light source is at least one white LED.

17. The method of claim 1, further including automatically actuating the light source upon detection of motion of the tool light and automatically deactivating the light source after a prolonged period of non-use.

18. The method of claim 1, further including adjusting the intensity of the at least one light source.

19. A method of illuminating a work area for a tool, comprising the steps of:
mounting a tool light to a rotational part of a rotational tool;
illuminating the work area with at least one LED of the tool light.

20. The method of claim 19, wherein the tool light includes a sleeve and the rotational part includes a handle, and the step of mounting includes sliding the sleeve over the handle.

21. The method of claim 20, wherein the sleeve includes at least one retractable LED powered by at least one battery.

22. The method of claim 19, wherein the rotational part includes a rotatable shaft, and the step of mounting includes using a mounting mechanism of the tool light to mount the tool light to the rotatable shaft.

23. The method of claim 22, wherein the tool light rotates with the shaft.

24. The method of claim 22, wherein the tool light does not rotate with the shaft.

25. A tool light for illuminating a work area for a tool, the tool including a shaft, comprising:
a mounting mechanism to be mounted to the shaft of the tool;
a housing carried by the mounting mechanism;
at least one light source and at least one power source housed within the housing, the at least one light source powered by the at least one power source to illuminate the work area for the tool.

26. The tool light of claim 25, wherein the mounting mechanism is adapted to slidably receive the shaft of the tool for mounting the tool light to the tool.

27. The tool light of claim 25, wherein the mounting mechanism is adapted to be clamped to the shaft of the tool for mounting the tool light to the tool.

28. The tool light of claim 25, wherein the light housing is rotatable in generally a horizontal plane to orient the at least one light source to a desired lighting position.

29. The tool light of claim 25, wherein the light housing is rotatable in generally a vertical plane to orient the at least one light source to a desired lighting position.

30. The tool light of claim 25, wherein the mounting mechanism includes a tightening mechanism to tighten the mounting mechanism to the shaft.

31. The tool light of claim 25, wherein the shaft is rotatable and the mounting mechanism is adapted to be mounted to the shaft so that the tool light rotates with the shaft while the shaft is rotated.

32. The tool light of claim 25, wherein the mounting mechanism is adapted to be mounted to the shaft so that the tool light does not rotate with the shaft while the shaft is rotated.

33. The tool light of claim 25, wherein the tool light has an annular shape and a central portion that is adapted to slidably receive the shaft therethrough for positioning the tool light at a desired location on the shaft.

34. The tool light of claim 25, wherein the at least one light source is powered by a rechargeable power source.

35. The tool light of claim 25, wherein the at least one light source is powered by at least one battery selected from the group consisting of an AA battery, an AAA battery, and an AAAA battery.

36. The tool light of claim 25, wherein the at least one light source is powered by at least one watch battery.

37. The tool light of claim 25, wherein the housing includes an on/off switch to switch the at least one light source on and off.

38. The tool light of claim 25, further including an automatic actuation and deactivation mechanism that automatically actuates the at least one light source upon detection of motion of the tool light and automatically deactivates the light source after a prolonged period of non-use.

39. The tool light of claim 25, further including a dimmer mechanism to adjust the intensity of the at least one light source.

40. The tool light of claim 25, wherein the at least one light source is at least one LED.

41. The tool light of claim 25, wherein the at least one light source is at least one white LED.
